(19) United States
(12) Patent Application Publication
(10) Pub. No.: US 2011/0068065 A1
(43) Pub. Date: Mar. 24, 2011

(54) FILTER ASSEMBLY

(75) Inventors: Thomas M. Garland, East Peoria, IL (US); Daniel R. Ibrahim, Metamora, IL (US)

(73) Assignee: Caterpillar Inc., Peoria, IL (US)

(21) Appl. No.: 12/562,497

(22) Filed: Sep. 18, 2009

(51) Int. Cl. B01D 37/00

(52) U.S. Cl. 210/806; 210/346

(57) ABSTRACT

A filter assembly for filtering particles from a fluid is disclosed. The filter assembly comprises a first plate, a second plate, and a channel. The first plate includes a first face, a second face, and a first set of apertures extending between the first face and the second face. The second plate includes a third face, a fourth face, and a second set of apertures extending between the third face and the fourth face. The second plate is coupled to the first plate such that the third face faces the second face. The channel is between at least a portion of the second face and at least a portion of the third face. The channel provides fluid communication between the first set of apertures and the second set of apertures and has a depth. The depth of the channel determines a filtration level.

### TECHNICAL FIELD

The present disclosure relates to a filter assembly. More particularly, the present disclosure relates to a filter assembly for use with various fluid systems.

### BACKGROUND

Modern fluid systems, such as common rail fuel systems and hydraulic systems, are increasingly becoming more precise and efficient. This is due in large part to the creation of systems that are able to reduce or minimize undesirable fluid leakage within these systems, such as leakage past seals, interfaces, valve elements, etc. One of the factors that is enabling this reduction in leakage is the manufacture and use of more precision parts and components that are manufactured to exacting tolerances. While these precision parts and components normally operate quite well, they tend to be more susceptible to damage from debris, such as the various types of debris that may be carried in the operating fluid (e.g., fine dust particles, sand, worn off material from other components within the system, etc.). Accordingly, including the appropriate filtration systems within these fluid systems can be very important.

Many modern fluid systems include a filtration system that includes a series of successively finer filtration elements through which the fluid passes as it travels through the system. These filtration systems may take a multitude of different configurations, depending on the application in which they are used. The objective of each filtration system is to ultimately filter out those particles from the fluid that can damage the components of the fluid system. However, like other components, the components within the filtration system are susceptible to failure due to manufacturing defects, misuse, damage, or other reasons. Depending on type of failure, the failure of one filtration element may lead to the failure of other filtration elements, and eventually, to the failure of the entire filtration system. Such a failure may occur slowly, in which case an operator may be able to remedy it before any damage to the fluid system results, or it may occur rapidly, in which case an operator may not be able to fix the filtration system before damage to the fluid system results.

Incorporating conventional backup filtration systems or elements that could at least prevent some of the larger and more harmful debris particles from making their way to the precision fluid system components before the primary filtration system can be repaired can add significant cost, complexity, and may require additional space that is often very limited. Similarly, for fluid systems with less demanding filtration requirements, the incorporation of many conventional filtration systems may add significant cost to the fluid system, introduce robustness or durability issues, and consume limited space.

It would be desirable to provide a filter assembly that is able to overcome one or more of the shortcomings described above and/or other shortcomings.

### SUMMARY

According to one exemplary embodiment, a filter assembly for filtering particles from a fluid comprises a first plate, a second plate, and a channel. The first plate includes a first face, a second face, and a first set of apertures extending between the first face and the second face. The second plate includes a third face, a fourth face, and a second set of apertures extending between the third face and the fourth face. The second plate is coupled to the first plate such that the third face faces the second face. The channel is between at least a portion of the second face and at least a portion of the third face. The channel provides fluid communication between the first set of apertures and the second set of apertures and has a depth. The depth of the channel determines a filtration level.

According to another exemplary embodiment, a method of filtering particles from a fluid comprises the steps of directing the fluid through a first set of apertures provided in a first plate having a first face and a second face opposite the first face, directing the fluid through a second set of apertures provided in a second plate having a third face and a fourth face opposite the third face, directing the fluid through a channel formed between the second face of the first plate and the third face of the second plate, and stopping at least most of the particles having a size greater than a depth of the channel from going through the second set of apertures.

According to another exemplary embodiment, a filter assembly for filtering particles from a fluid comprises a first plate, a second plate, and a recessed region. The first plate includes a first face, a second face, and a first set of apertures extending between the first face and the second face. The second plate is coupled to the first plate and includes a third face, a fourth face, and a second set of apertures extending between the third face and the fourth face. The recessed region is defined by a recess extending into one of the second face of the first plate and the third face of the second plate. The recess has a depth. At least a portion of the second face of the first plate abuts at least a portion of the third face of the second plate. The recessed region fluidly couples the first set of apertures with the second set of apertures. The depth of the recess determines a filtration level.

### BRIEF DESCRIPTION OF THE DRAWINGS

FIG. 1 is a schematic illustration of a fuel system for an engine according to one exemplary embodiment.

FIG. 2 is a cross-sectional side view of a filter assembly according to one exemplary embodiment.

FIG. 3 is a top view of the upper plate of the filter assembly of FIG. 2.

FIG. 4 is a top view of the lower plate of the filter assembly of FIG. 2.

FIG. 5 is a cross-sectional side view of a filter assembly according to another exemplary embodiment.

### DETAILED DESCRIPTION

Reference will now be made in detail to specific embodiments or features, examples of which are illustrated in the accompanying drawings. Generally, the same or corresponding reference numbers will be used throughout the drawings to refer to the same or corresponding parts.

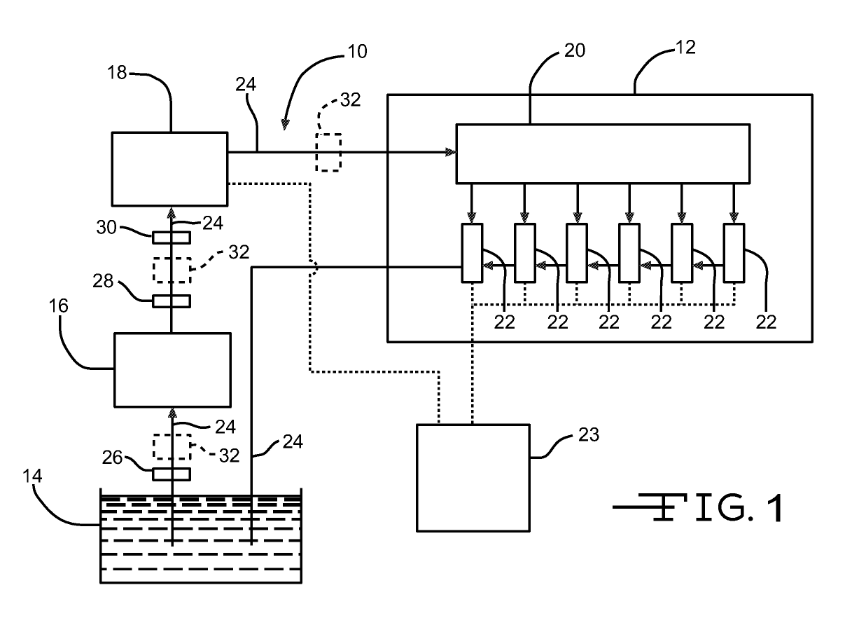

Referring generally to FIG. 1, a fuel system 10 is shown according to one exemplary embodiment. Fuel system 10 is a system of components that cooperate to deliver fuel (e.g., diesel fuel, gasoline, heavy fuel, etc.) from a location where fuel is stored to the combustion chamber(s) of an engine 12 where it will combust and where the energy released by the combustion process will be captured by engine 12 and used to generate a mechanical source of power. Although depicted in FIG. 1 as a fuel system for a diesel engine, fuel system 10 may be the fuel system of any type of engine (e.g., an internal combustion engine such as a gaseous fuel or gasoline engine, a turbine, etc.). Also, although depicted as a common rail fuel system, the fuel system could take other configurations as well, such as a fuel system utilizing mechanically actuated unit injectors, hydraulically actuated unit injectors, mechanically or hydraulically intensified common rail injectors, and other types of fuel systems. According to one exemplary embodiment, fuel system 10 is a common rail fuel system and includes a tank 14, a transfer pump 16, a high-pressure pump 18, a common rail 20, fuel injectors 22, an electronic control module (ECM) 23, tubing 24, a primary filter 26, a secondary filter 28, a tertiary filter 30, and a filter assembly 32.

Tank 14 is a storage container that stores the fuel that fuel system 10 will deliver. Transfer pump 16 pumps fuel from tank 14 and delivers it at a generally low pressure to high-pressure pump 18. High-pressure pump 18, in turn, pressurizes the fuel to a high pressure (suitable for injection) and delivers the fuel to common rail 20. Common rail 20, which is intended to be maintained at the high pressure generated by high-pressure pump 18, serves as the source of high-pressure fuel for each of fuel injectors 22. Fuel injectors 22 are located within engine 12 in a position that enables fuel injectors 22 to inject high-pressure fuel into the combustion chambers of engine 12 (or into pre-chambers or ports upstream of the combustion chambers in some cases) and generally serve as metering devices that control when fuel is injected into the combustion chamber, how much fuel is injected, and the manner in which the fuel is injected (e.g., the angle of the injected fuel, the spray pattern, etc.). Each fuel injector 22 is continuously fed fuel from common rail 20 such that any fuel injected by a fuel injector 22 is replaced by additional fuel supplied by common rail 20. ECM 23 is a control module that receives multiple input signals from sensors associated with various systems of engine 12 (including fuel system 10) and indicative of the operating conditions of those various systems (e.g., common rail fuel pressure, fuel temperature, throttle position, engine speed, etc.). ECM 23 uses those inputs to control, among other engine components, the operation of high-pressure pump 18 and each of fuel injectors 22. The purpose of fuel system 10 is to ensure that the fuel is constantly being fed to engine 12 in the appropriate amounts, at the right times, and in the right manner to support the operation of engine 12.

Flow passages 24 generally serve as the structure used for conveying or transporting the fuel within fuel system 10. According to various exemplary and alternative embodiments, flow passages 24 may be formed from any one or more of a variety of different structures and configurations, including tubes, pipes, conduits, ducts, hoses, etc. The flow passages within different fuel systems may be formed from one or more of these different structures or configurations, and flow passages at different locations within a fuel system may be formed from different structures or configurations. For example, flow passage 24 between tank 14 and transfer pump 16 may be formed from a different structure than that which is used between high-pressure pump 18 and common rail 20, or between common rail 20 and each of fuel injectors 22, due at least in part to the magnitude of the pressure flow passages 24 will be exposed to at different locations within fuel system 10. According to other various exemplary and alternative embodiments, the flow passages may take any one of a variety of forms and configurations that are suitable for the particular fuel system in which they are used as well as the location in which the tubing or flow passages are used within the fuel system. For example, the tubing or flow passages may take the form of straight tubes, bent tubes, thin-walled tubes, thick-walled tubes, quill tubes, internal passages within other structures, and other forms and configurations.

Fuel system 10 may optionally include various filtration arrangements. For example, according to one exemplary embodiment, fuel system 10 includes a primary filter 26 (which may also serve as a water separator) located between tank 14 and transfer pump 16, a secondary filter 28 located between transfer pump 16 and high-pressure pump 18, and a tertiary filter 30 also located between transfer pump 16 and high-pressure pump 18. According to various exemplary and alternative embodiments, the number of filters used in a particular fuel system, the location of the filters, and the filtration level (e.g., 2, micron, 4 micron, 10 micron, 30 micron, etc.) of each filter may be suitably adapted to a particular fuel system, based at least in part on the characteristics of the fuel systems (e.g., its tolerance to debris) and the environment in which it is likely to be used.

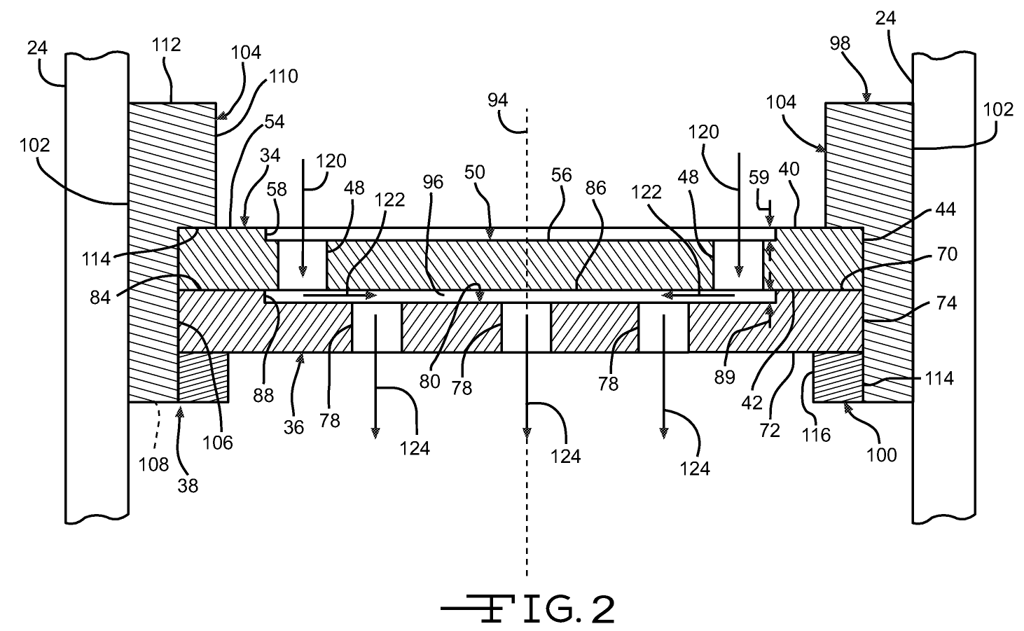

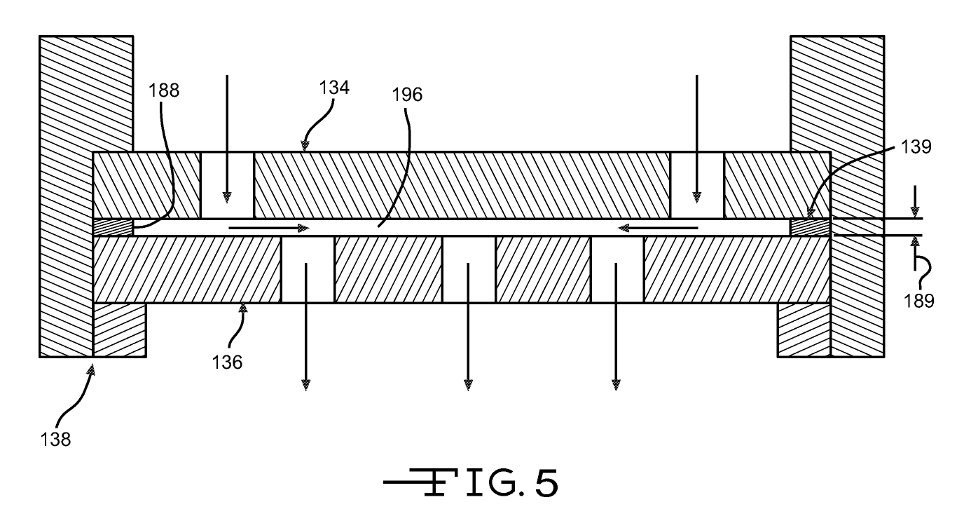

Referring now to FIGS. 2 through 4, filter assembly 32 serves as a mechanism for stopping (or substantially stopping) particles larger than a particular size that are within a fuel stream (or other fluid) from passing beyond filter assembly 32. As illustrated in FIG. 1, and according to various exemplary and alternative embodiments, one or more filter assemblies 32 may be used in one or more locations within fuel system 10. According to one exemplary embodiment, filter assembly 32 includes a plate 34, a plate 36, and a retention assembly 38.

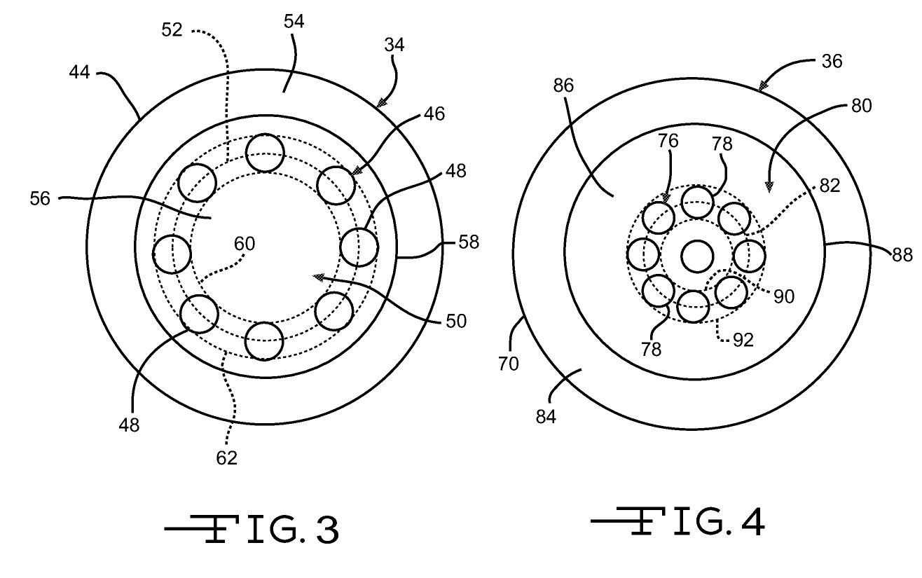

According to one exemplary embodiment, plate 34 (e.g., panel, disc, member, etc.) is a generally flat, circular element that includes a face 40, an opposing face 42, an outer edge 44, and a hole or aperture pattern 46 made up of one or more apertures or holes 48. Faces 40 and 42 are generally parallel to one another and are spaced apart to define a thickness of plate 34. Face 42 is defined by a substantially planar surface. Face 40 includes a circular recess 50, which creates within face 40 a nonrecessed surface 54, a recessed surface 56, and an edge 58 that extends between nonrecessed surface 54 and recessed surface 56 and that defines the shape of recess 50. A depth 59 of recess 50 determines the distance the plane defined by recessed surface 56 is spaced apart from the plane defined by nonrecessed surface 54. Outer edge 44 of plate 34 extends generally perpendicularly between the outer periphery of faces 40 and 42. Hole pattern 46 is illustrated in FIG. 3 as eight holes 48 arranged in a circular pattern in which the center of each hole 48 is located on a circle 52 and uniformly spaced around circle 52. In this arrangement, each of holes 48 are provided within a ring or band defined by the area between an inner circle 60 and an outer circle 62. To position each of holes 48 within recess 50, the diameter of outer circle 62 is less than the diameter of recess 50.

According to one exemplary embodiment, plate 36 (e.g., panel, disc, member, etc.) is a generally flat, circular element that includes a face 70, an opposing face 72, an outer edge 74, and a hole or aperture pattern 76 made up of one or more holes or apertures 78. Faces 70 and 72 are generally parallel to one another and are spaced apart to define a thickness of plate 36. Face 72 is defined by a substantially planar surface. Face 70 includes a circular recess 80, which creates within face 70 a nonrecessed surface 84, a recessed surface 86, and an edge 88 that extends between nonrecessed surface 84 and recessed surface 86 and that defines the shape of recess 80. A depth 89 of recess 80 determines the distance the plane defined by recessed surface 86 is spaced apart from the plane defined by nonrecessed surface 84. Outer edge 74 of plate 36 extends generally perpendicularly between the outer periphery of faces 70 and 72. Hole pattern 76 is illustrated in FIG. 3 as nine holes 78, eight of which are arranged in a circular pattern in which the center of each hole 78 is located on a circle 82 and uniformly spaced around circle 82, and one of which is located in the center of circle 82. In this arrangement, all but one of holes 78 are provided within a ring or band defined by the area between an inner circle 90 and an outer circle 92. To position each of holes 78 within recess 80, the diameter of outer circle 92 is less than the diameter of recess 80. Relative to hole pattern 46 of plate 34, the diameter of outer circle 92 of plate 36 is less than the diameter of inner circle 60 of plate 34. As a result, none of the individual areas consumed by the individual holes 78 of plate 36 overlap any of the individual areas consumed by the individual holes 48 of plate 34.

Plates 34 and 36 are located relative to one another such that they share a common axis 94 and face 42 of plate 34 abuts or rests against nonrecessed surface 84 of face 70 of plate 36. In this position, a channel or gap 96 is formed between plate 34 and plate 36 that is defined by recess 80 within plate 36. Channel 96 provides a restricted flow path (e.g., fluid communication) between holes 48 and holes 78, the depth of which can be altered by altering the depth of recess 80.

According to various exemplary and alternative embodiments, each of plates 34 and 36 may take one of a multitude of different configurations that may be selected based at least in part on the characteristics of the fluid system in which filter assembly 32 is used (e.g., flow rates, desired filtration levels, type of fluid, fluid temperatures, etc.). For example, the apertures in each plate may be provided in one or more of a variety of different shapes and may, for example, be circular, oval, or rectangular, or be slots or slits, or may take one of a variety of other shapes. Similarly, the hole pattern of each plate may take one of a variety of different configurations by varying the locations of the holes (e.g., the hole pattern), the size and/or shape of one or more of the holes, and/or the number of holes in the pattern. Similarly, each of the plates may take one of a variety of different shapes, and both plates may have the same shape or they may have different shapes. For example, one or both of the plates may be flat and have a square, oval, triangular, rectangular, trapezoidal, or any other shape, or one or both of the plates may be contoured in some way. For example, one or both of the plates may be concave, convex, conical, domed, pointed, etc. Furthermore, the shape, size, and depth of the recess in each plate may be altered to tailor the level of filtration to be suitable for a particular application. Moreover, the filter assembly may include more than two plates (e.g., more than one filtration level or more than one pass at the same filtration level). For example, the filter assembly may include three plates stacked together to form two channels (one between the first and second plate, and one between the second and third plate). The channels may be the same size, shape, and depth, or they may be different sizes, shapes, and/or depths to accomplish different filtration levels. Further, only one of the two plates may include a recess, or each plate may include more than one recess (e.g., a recess on each face). Moreover, the channel between the two plates may be formed by a recess in one plate or by the recesses in two plates. According to other exemplary and alternative embodiments, the plates may take any one of a variety of other configurations and may be selectively combined to tailor the characteristics of the filter assembly.

Retention assembly 38 serves as the structure or mechanism that holds plates 34 and 36 in position relative to one another and that may facilitate the mounting of filter assembly 32 within a flow passage 24. According to one exemplary embodiment, retention assembly 38 includes a receiver 98 that is configured to receive plates 34 and 36 and a retainer 100 that is configured to retain plates 34 and 36 within receiver 98.

According to one exemplary embodiment, receiver 98 (e.g., body, receptacle, container, etc.) is a rigid, tube-shaped member that includes an outer surface 102 and an inner surface 104. Outer surface 102 has a generally cylindrical shape that is configured to facilitate the coupling of filter assembly 32 within a portion of a flow passage 24 (e.g., pipe, tube, etc.), various fittings, or other portions of a fluid system. According to various exemplary and alternative embodiments, the outer surface of receiver 98 may be smooth, rough, tapered, notched, grooved, threaded, or may include any one or more of a variety of engagement structures (e.g., groove, projection, etc.) that facilitate the coupling of filter assembly 32 within a fluid system. Inner surface 104 includes a first portion 106 that extends axially inwardly from an end 108, a second portion 110 having a diameter smaller than that of first portion 106 and extending axially inwardly from an opposite end 112, and a radially extending shoulder 114 that extends between first portion 106 and second portion 110. In such a configuration, first portion 106 receives plates 34 and 36 and shoulder 114 serves as a stop that cooperates with retainer 100 to hold plates 34 and 36 together. According to various exemplary and alternative embodiments, the first portion may be configured in one of a variety of different ways to receive plates 34 and 36 and cooperate with retainer 100 to retain plates 34 and 36. For example, the first portion may be sized to freely receive plate 34 and 36, it may be sized to receive either or both of plates 34 and 36 and/or retainer 100 as a press-fit, it may be at least partially threaded to receive cooperating threads provided on retainer 100 or on one or both of plates 34 and 36, it may include a groove configured to receive a snap ring, it may include structure that can be crimped or rolled to retain plates 34 and 36 in place, or in may be configured in one of a plurality of different ways to cooperate with retainer 100, plate 34, plate 36, and/or another member to retain plates 34 and 36 in position relative to one another.

According to one exemplary embodiment, retainer 100 is a ring-shaped member that engages receiver 98 to retain plates 34 and 36 in position relative to one another and includes an outer surface 115 and an inner surface 116. Outer surface 115 engages first portion 106 of receiver 98 to retain retainer 100 at an axial position within receiver 98 that is sufficient to hold plates 34 and 36 together. According to various exemplary and alternative embodiments, outer surface 115 may be configured in one of a variety of different ways to couple retainer 100 to receiver 98 in such a way that plates 34 and 36 are held within receiver 98. For example, the outer surface may include threads that engage corresponding threads on first portion 106 of receiver 98, it may be sized to be received within receiver 98 through a press-fit, or it may be configured in one of a plurality of different ways to cooperate with receiver 98, plate 34, plate 36, and/or another member to retain plates 34 and 36 in position relative to one another. Inner surface 116 generally defines an opening in retainer 100 that allows fluid passing through plates 34 and 36 to pass through retainer 100. According to other exemplary and alternative embodiments, retainer 100 may take one of a variety of different forms and configurations. For example, retainer 100 may be provided in the form of a snap ring that is configured to fit within a cooperating groove provided in receiver 98, it may be integrally formed with receiver 98 and may take the form of a structure that can be crimped or rolled to retain plates 34 and 36 in place. According to another alternative embodiment, the retainer may be excluded and plates 34 and 36 may be held in place by other means, such as through welding, the use of adhesives, brazing, crimping, cooperating threads, or other means.

According to various alternative and exemplary embodiments, retention assembly 38 may be replaced by any suitable structure, device, or element that can hold plates 34 and 36 together. For example, plates 34 and 36 may be held together by fasteners (e.g., screws or bolts), springs, various collars, slots or grooves in other elements within the fluid system that receives plates 34 and 36. According to still other various alternative and exemplary embodiments, any structure serving to hold plates 34 and 36 together may be formed separately from plates 34 and 36 or may be integrally formed as part of either or both of plates 34 and 36.

Referring now to FIG. 5, a filter assembly 132 is shown according to another exemplary embodiment. Filter assembly 132 is similar to filter assembly 32, in that it includes a plate 134, a plate 136, and a retention assembly 138. However, instead of utilizing a recess in plate 36 to create channel 96, as is done with filter assembly 32, filter assembly 132 utilizes a ring-shaped spacer 139 (e.g., washer, disk, etc.) located between two flat plates 134 and 136 to create a channel 196 between plates 134 and 136. With such a configuration, the shape of channel 196 is defined by an inner surface 188 of spacer 139 and the depth of channel 196 is defined by a height 189 of spacer 139. Thus, the desired filtration level of filter assembly 132 can be easily selected by using a spacer having a height approximately equal to the desired filtration level.

According to various exemplary and alternative embodiments, plates 34 and 36, receiver 98 and retainer 100 may each be made from any one or more of a variety of different materials, including various elastomers, polymers, metals, composites, etc, depending on the environment in which the filter assembly is used (e.g., fluid pressure, flow rate, the nature of the fluid, temperature of the fluid, etc.) and the required performance characteristics of the filter assembly components. For example, if the filter assembly is used in a low-pressure, low flow fluid system, one or more of plates 34 and 36, receiver 98, and retainer 100 may be constructed from a polymer. However, if the filter assembly is used in a high-pressure, high flow fluid system, one or more of plates 34 and 36, receive 98, and retainer 100 may be constructed from more durable materials such as metal.

Although filter assembly 32 is described above primarily in connection with fuel system 10, filter assembly 32 may be adapted for use in any one of a variety of different fluid systems, such as high-pressure and low-pressure systems, systems using one or more of a variety of different fluids (e.g., fuel, oil, water, urea, coolant, solvent, etc.), systems with different fluid temperatures, systems in different operating environments, etc. Filter assembly 32 may also be used within the fluid systems of many different devices such as, for example, engines, pumps, transmissions, aftertreatment systems, etc. Filter assembly 32 may also be used at one or more different positions within a fluid system. For example, it may be placed within a tube, it may be integrated into a fitting or other component of the fluid system, it may placed at an inlet or an outlet, or it can be placed in other positions or locations.

Although filter assemblies 32 and 132 are each illustrated as having generally flat plates that are arranged perpendicular to the flow of the fluid as it enters the filter assembly, each filter assembly may, according to various alternative embodiments, include one or more plates that are oriented non-perpendicularly relative to the input flow of fluid, or one or more plates may include portions that are oriented non-perpendicularly to the input flow of fluid. For example, both plates could be flat and be oriented 45 degrees relative to the direction of the input flow of fluid. Similarly, both plates could be cone-shaped (e.g., in a cone within a cone configuration) such that the surface into which the fluid enters is not perpendicular to the direction of flow of the input fluid.

### INDUSTRIAL APPLICABILITY

In many modern fluid systems where the size of components and the tolerances between interacting components are being reduced, keeping potentially harmful particles from passing through the sensitive components of the fluid system is becoming increasingly important. Although there are different ways to accomplish this, the use of one or more filtration apparatuses is one of the most common and practical. Filter assemblies 32 and 132 are two such filtration apparatuses that may be useful to filter out particles larger than a particular, predetermined size to prevent most, if not all, of those particles from passing beyond the filter assembly and possibly causing damage to one or more of the components of the fluid system that are susceptible to being damaged by those particles.

The operation of filter assembly 32 will now be described. It should be noted, however, that the operation of filter assembly 132 will not be described, it being understood that its operation is substantially similar to that of filter assembly 32. Referring to FIG. 2, filter assembly 32 is positioned within a portion of flow passage 24 such that fluid flowing within flow passage 24 flows toward plate 34. Because most of plate 34 is a solid, nonpermeable structure, the only place for the fluid to continue to flow is through holes 48. Thus, as indicated by arrows 120, the fluid flows through holes 48. Once the fluid passes through holes 48, it enters gap 96 (as indicated by arrows 122) and is then forced to flow laterally between plate 34 and plate 36 within gap 96 until the fluid reaches one of holes 78. Then, as indicated by arrows 124, the fluid is permitted to flow out of filter assembly 32 through holes 78. When the fluid is forced to flow laterally within gap 96 between plates 34 and 36, only those particles in the fluid that are able to fit into gap 96 will be able to continue to travel along with the flow of fluid and ultimately exit filter assembly 32 through holes 78. Those particles in the fluid that are not able to fit into gap 96 will either become trapped or will otherwise not be permitted to exit filter assembly 32. In this way, filter assembly 32 functions to filter out of the fluid stream those particles that are not able to fit within or pass through gap 96.

The level of filtration of filter assembly 32 is determined by the size of gap 96. The size of gap 96 is determined by the size, or more specifically the height or depth, of recess 80 of plate 36. Thus, altering the depth of recess 80 in plate 36 has the effect of altering the level of filtration of filter assembly 32.

Unlike many screen type filters, where the filtration is accomplished by simply passing fluid through a series of holes or openings having a certain size and then filtering out particles that are larger than the hole size, the level of filtration of filter assembly 32 is not dependent on the ability to manufacture holes or openings that are small enough to achieve the desired filtration level. Utilizing common manufacturing techniques, a very shallow recess can be machined into a plate more easily and consistently than a similarly sized holed can be machined (e.g., drilled) in the plate. Thus, by utilizing a recess to provide the filtration level rather than a hole, finer levels of filtration may be more easily achieved.

Although the fluid path illustrated in FIG. 2 is shown flowing from plate 34 to plate 36 (with the fluid flowing radially inwardly between the plates), filter assembly 32 is also capable of providing the same level of filtration when the fluid is moving in the opposite direction (e.g., from plate 36 to plate 34). Thus, the bi-directional nature of filter assembly 32 may help to alleviate assembly errors that could otherwise occur with a unidirectional filter that is assembled into the system in the wrong direction or orientation. Similarly, the addition of a recess to both plate 34 and 36, although not necessary, may help to alleviate or reduce assembly errors by making the positions of plates 34 and 36 interchangeable.

According to various alternative and exemplary embodiments, the filter assembly may be used within a fluid system for different purposes, including as the sole means of filtration, a first level of filtration, a second, third, or larger level of filtration, or as a backup filter that can help protect the fluid system if the other levels of filtration fail.

It is important to note that the construction and arrangement of the elements of the filter assembly as shown in the exemplary and alternative embodiments are illustrative only. Although only a few embodiments of the filter assembly have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, orientations, etc.) without materially departing from the novel teachings and advantages of the subject matter recited. For example, elements shown as integrally formed may be constructed of multiple parts or elements shown as multiple parts may be integrally formed, the operation and relative orientations of the interfaces (e.g., recesses, holes, etc.) may be reversed or otherwise varied, the length, width, diameter, or shape of the structures and/or members or connectors or other elements of the system may be varied, and/or the nature or number of different relative positions of the components may be varied (e.g., by variations in the locations, lengths, depths, or angles of the recesses, spacers, retainer, receiver, etc.). It should be noted that the elements and/or assemblies of the filter assembly may be constructed from any of a wide variety of materials that provide sufficient strength or durability, and in any of a wide variety of textures and combinations. It should also be noted that the filter assembly may be used in association with any of a wide variety of different fluid systems or fluid subsystems and in any of a wide variety of applications. Accordingly, all such modifications are intended to be included within the scope of the present disclosure. Other substitutions, modifications, changes and omissions may be made in the design, operating conditions and arrangement of the exemplary and alternative embodiments without departing from the spirit of the present disclosure.

What is claimed is:

1. A filter assembly for filtering particles from a fluid, the filter assembly comprising:
a first plate including a first face, a second face, and a first set of apertures extending between the first face and the second face;
a second plate including a third face, a fourth face, and a second set of apertures extending between the third face and the fourth face, the second plate being coupled to the first plate such that the third face faces the second face; and
a channel between at least a portion of the second face and at least a portion of the third face, the channel providing fluid communication between the first set of apertures and the second set of apertures and having a depth;
wherein the depth of the channel determines a filtration level.

2. The filter assembly of claim 1, wherein one of the second face of the first plate and the third face of the second plate includes a recess, and wherein the recess defines the channel.

3. The filter assembly of claim 1, further comprising a spacer between the second face of the first plate and the third face of the second plate, wherein the spacer defines the depth of the channel.

4. The filter assembly of claim 1, wherein the first face of the first plate includes a first recess and the third face of the second plate includes a second recess.

5. The filter assembly of claim 1, wherein the first set of apertures includes at least two apertures, and wherein each of the at least two apertures of the first set of apertures is the same size and shape.

6. The filter assembly of claim 5, wherein the second set of apertures includes at least two apertures, and wherein each of the at least two apertures of the second set of apertures is the same size and shape.

7. The filter assembly of claim 1, wherein the first set of apertures includes a different number of apertures than the second set of apertures.

8. The filter assembly of claim 1, wherein the first plate and the second plate share a common axis, and wherein fluid traveling between the first set of apertures and the second set of apertures within the channel travels in a direction substantially perpendicular to the common axis.

9. The filter assembly of claim 1, wherein each of the first plate and the second plate is circular.

10. The filter assembly of claim 1, further comprising a retention assembly, the retention assembly receiving the first plate and the second plate.

11. The filter assembly of claim 1, wherein the first set of apertures includes at least two apertures.

12. The filter assembly of claim 1, wherein the second set of apertures includes at least two apertures.

13. A method of filtering particles from a fluid comprising the steps of:
directing the fluid through a first set of apertures provided in a first plate having a first face and a second face opposite the first face;
directing the fluid through a second set of apertures provided in a second plate having a third face and a fourth face opposite the third face;
directing the fluid through a channel formed between the second face of the first plate and the third face of the second plate; and
stopping at least most of the particles having a size greater than a depth of the channel from going through the second set of apertures.

14. The method of claim 13, wherein the step of directing the fluid through a channel further comprises the step of directing the fluid through a recess provided in one of the second face and the third face.

15. The method of claim 13, wherein the second face of the first plate and the third face of the second plate are spaced apart by a spacer, and wherein the step of directing the fluid through a channel further comprises the step of directing the fluid through the space between the second face of the first plate and the third face of the second plate.

16. A filter assembly for filtering particles from a fluid, the filter assembly comprising:
a first plate including a first face, a second face, and a first set of apertures extending between the first face and the second face;
a second plate coupled to the first plate and including a third face, a fourth face, and a second set of apertures extending between the third face and the fourth face; and
a recessed region defined by a recess extending into one of the second face of the first plate and the third face of the second plate, the recess having a depth;
wherein at least a portion of the second face of the first plate abuts at least a portion of the third face of the second plate;
wherein the recessed region fluidly couples the first set of apertures with the second set of apertures; and
wherein the depth of the recess determines a filtration level.

17. The filter assembly of claim 16, wherein the recess extends into the third face of the second plate.

18. The filter assembly of claim 17, wherein the first face of the first plate includes a second recess.

19. The filter assembly of claim 16, wherein the first set of apertures includes at least two apertures, and wherein each of the at least two apertures of the first set of apertures is the same size and shape.

20. The filter assembly of claim 19, wherein the second set of apertures includes at least two apertures, and wherein each of the at least two apertures of the second set of apertures is the same size and shape.

21. The filter assembly of claim 16, wherein the first set of apertures includes a different number of apertures than the second set of apertures.

22. The filter assembly of claim 16, wherein the first plate and the second plate share a common axis, and wherein fluid traveling between the first set of apertures and the second set of apertures within the recessed region travels in a direction substantially perpendicular to the common axis.

23. The filter assembly of claim 16, wherein each of the first plate and the second plate is circular.

24. The filter assembly of claim 16, further comprising a retention assembly, the retention assembly receiving the first plate and the second plate.
